(19) United States
(12) Patent Application Publication
(10) Pub. No.: US 2024/0414123 A1
(43) Pub. Date: Dec. 12, 2024

(54) Zero Trust Data Gateway

(71) Applicant: XQ Message Inc., Walnut Creek, CA (US)

(72) Inventors: Brian WANE, Walnut Creek, CA (US); Ikechi ECHEBIRI, Riverside, CA (US); Junaid ISLAM, San Jose, CA (US)

(21) Appl. No.: 18/398,073

(22) Filed: Dec. 27, 2023

Related U.S. Application Data
(60) Provisional application No. 63/435,539, filed on Dec. 27, 2022.

(51) Int. Cl. H04L 9/40

(52) U.S. Cl. CPC H04L 63/0209; H04L 9/40

(57) ABSTRACT

Zero-Trust Data enabled software encryption gateway, used for end-to-end encrypted data transmissions between devices, networks, and applications. Application transmits time-limited encrypted traffic between two or more endpoints, while giving users ability to revoke access to their data from a connected dashboard at any point in time. A gateway receives data from a client and filters this data to obtain two or more data streams or substreams, which the gateway securely transmits to the two or more different endpoints.

### CROSS-REFERENCE TO RELATED APPLICATIONS

This application claims the benefit of U.S. application 63/435,539, filed Dec. 27, 2022. This application is incorporated by reference along with all other references cited in this application.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

This invention relates to data protection software and techniques and more specifically to encryption and decryption of digital data and objects.

VPNs and VPN replacements are slow, expensive, and difficult to manage. Improved protection is needed that offers a more future-proof, scalable approach to securing corporate data transfer and apps.

There is a need for improved approaches to securing digital information and computing systems and networks.

### BRIEF SUMMARY OF THE INVENTION

Zero Trust is a new security model being mandated by the U.S. government for DoD, federal agencies, and mission-critical industries. Some implementations of Zero Trust are network based are referred to as Zero Trust Network Applications (ZTNA). The heart of the Zero-Trust Data Architecture (ZTDA) is that all users and devices attaching to networked resources are authenticated and authorized. XQ is the first company to extend ZTDA for data protection. XQ Zero Trust enables policy-based access to any digital resource on owned infrastructure, across disparate networks and remote data access control.

The XQ Secure Gateway functions as a Zero-Trust Data (ZTD) Application. Traditional cyber security protects the app, identity, and network and leaves data to fend for itself. When a threat actor breaches a perimeter valuable data can be exposed or exfiltrated. We ensure that stolen data cannot be read, as the threat actor would neither have the correct identity nor authorization to access it. XQ provides a blast radius of one by disabling lateral movement between identities or data objects. Access to a single identity or data object does not grant access to adjacent assets.

XQ's ZTD platform benefits include: (i) Encrypt, track and monitor data wherever it goes; (ii) Uniquely encrypt each data object; (iii) Log the who, where and when of each interaction; (iv) Restrict access to authorized recipients, domains and geographies; (v) and Revoke access to data remotely.

XQ enables software developers and solution providers to integrate zero-trust data into their applications. We have developed a library of software agents to support a range of platforms from mobile phones and connected sensors, to cloud computers. An agent runs or executes on each client device, and is used to establish a secure channel to a gateway. The agent transmit the data (e.g., from multiple applications, sensors, or other components of the client) from the client to the gateway.

The XQ Secure Gateway plays a key role in allowing customers to take advantage of ZTDA without complicated integrations or extended development times.

In an implementation, a method includes: establishing a first secure connection between a first client and a first gateway; receiving first data over the first secure connection from the first client at the first gateway; at the first gateway, filtering the first data and mapping the first data in a first subdata and second subdata; transmitting the first subdata to a first location via second secure connection; and transmitting the second subdata to a second location via a third secure connection, where the second location is different from the first location.

In various implementations, the first secure connection, second secure connection, and third secure connection are encrypted connections. Filtering at the gateway can be performed based on rules or policies stored at the gateway. The first data can be an encoded video stream. The first data can be a secure file transfer protocol (SFTP) data. The first client can be on a first subnet and the first location is on a second subnet, different from the first subnet. The first secure connection can be encrypted using a first encryption key, the second secure connection can be encrypted using a second encryption key, and the third secure connection can be encrypted using a third encryption key, where the first, second, and third encryption keys are different from each other.

The method can include transmitting the first subdata to a second gateway via a fourth secure connection. The method can include transmitting the second subdata to a third gateway via a fifth secure connection.

Further the method can include: using a first encryption key to encrypt first data transmitted over the first secure connection; transmitting the first encryption key from the first gateway to the a server; storing the first encryption key at the server; at a second gateway, receiving the first encryption key from the server; and using the first encryption key to encrypt first subdata transmitted over the second secure connection.

In an implementation, a method includes: using only one network adapter interface, establishing a first secure connection between a first client and a first application endpoint and a second application endpoint over which to transmit data. where the establishing a first secure connection includes: establishing a second secure connection between the first client and a first gateway; receiving first data over the first secure connection from the first client at the first gateway; at the first gateway, filtering the first data to obtain a first subdata and second subdata; transmitting the first subdata to a first application endpoint via fourth secure connection; and transmitting the second subdata to a second application endpoint via a fourth secure connection, where the second application endpoint is different from the first application endpoint.

In various implementations, the filtering at the gateway is performed based on rules or policies stored at a gateway. The first data of the first client can include data from a first application or sensor of the first client and a second application of the first client.

The method can include storing an encryption key at a server, where the encryption key is used to encrypt first data. The method can include retrieving the encryption key from the server, where the encryption key is used to decrypt first subdata.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a simplified block diagram of a client-server system and network.

FIG. 2 shows a more detailed diagram of a client or server computer.

FIG. 3 shows a system block diagram of a client or system computer system.

FIGS. 4-5 show examples of mobile devices, which can be mobile clients.

FIG. 6 shows a system block diagram of mobile device.

FIG. 7 shows a flow of data from a source device to a destination device.

FIG. 8 shows a secure file services data flow example.

FIG. 9 shows a secure media streaming data flow example

FIG. 10 shows secure network bridging data flow example.

FIG. 11 shows a client system making secure network connections with two or more different endpoints via a communications network or gateway.

### DETAILED DESCRIPTION OF THE INVENTION

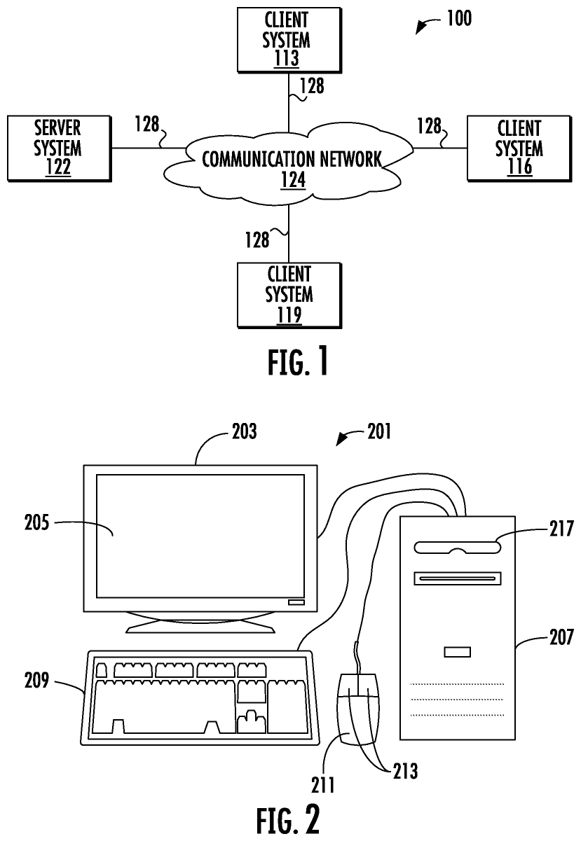

FIG. 1 is a simplified block diagram of a distributed computer network 100. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Communication links 128 may be DSL, Cable, Ethernet or other hardwire links, passive or active optical links, 3G, 3.5G, 4G and other mobility, satellite or other wireless communications links, wave propagation links, or any other mechanisms for communication of information.

Various communication protocols may be used to facilitate communication between the various systems shown in FIG. 1. These communication protocols may include VLAN, MPLS, TCP/IP, Tunneling, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention have been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, the client systems can run as a standalone application such as a desktop application or mobile smartphone or tablet application. In another embodiment, a “web browser” application executing on a client system enables users to select, access, retrieve, or query information stored by server system 122. Examples of web browsers include the Internet Explorer browser program provided by Microsoft Corporation, Firefox browser provided by Mozilla, Chrome browser provided by Google, Safari browser provided by Apple, and others.

In a client-server environment, some resources (e.g., files, music, video, or data) are stored at the client while others are stored or delivered from elsewhere in the network, such as a server, and accessible via the network (e.g., the Internet). Therefore, the user's data can be stored in the network or “cloud.” For example, the user can work on documents on a client device that are stored remotely on the cloud (e.g., server). Data on the client device can be synchronized with the cloud.

FIG. 2 shows an example of a client or server system. In an embodiment, a user interfaces with the system through a computer workstation system, such as shown in FIG. 2. FIG. 2 shows a computer system 201 that includes a monitor 203, screen 205, enclosure 207 (may also be referred to as a system unit, cabinet, or case), keyboard or other human input device 209, and mouse or other pointing device 211. Mouse 211 may have one or more buttons such as mouse buttons 213.

It should be understood that the present invention is not limited any computing device in a specific form factor (e.g., desktop computer form factor), but can include all types of computing devices in various form factors. A user can interface with any computing device, including smartphones, personal computers, laptops, electronic tablet devices, global positioning system (GPS) receivers, portable media players, personal digital assistants (PDAs), other network access devices, and other processing devices capable of receiving or transmitting data.

For example, in a specific implementation, the client device can be a smartphone or tablet device, such as the Apple iPhone (e.g., Apple iPhone 11), Apple iPad (e.g., Apple iPad or Apple iPad mini), Apple iPod (e.g, Apple iPod Touch), Samsung Galaxy product (e.g., Galaxy S series product or Galaxy Note series product), Google Nexus or Pixel devices (e.g., Nexus 6, Nexus 7, Nexus 9, of Pixel 4), and Microsoft devices (e.g., Microsoft Surface tablet). Typically, a smartphone includes a telephony portion (and associated radios) and a computer portion, which are accessible via a touch screen display.

There is nonvolatile memory to store data of the telephone portion (e.g., contacts and phone numbers) and the computer portion (e.g., application programs including a browser, pictures, games, videos, and music). The smartphone typically includes a camera (e.g., front facing camera or rear camera, or both) for taking pictures and video. For example, a smartphone or tablet can be used to take live video that can be streamed to one or more other devices.

Enclosure 207 houses familiar computer components, some of which are not shown, such as a processor, memory, mass storage devices 217, and the like. Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive or solid state drive (SSD)), battery-backed-up volatile memory, tape storage, reader, and other similar media, and combinations of these.

A computer-implemented or computer-executable version or computer program product of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

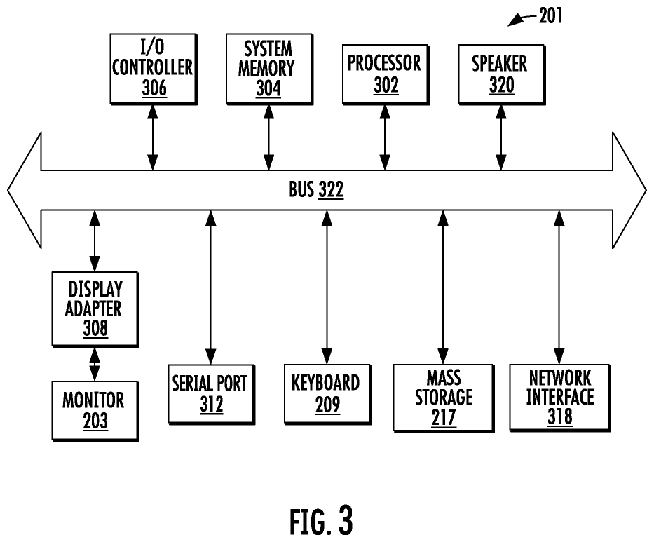

FIG. 3 shows a system block diagram of computer system 201. As in FIG. 2, computer system 201 includes monitor 203, keyboard 209, and mass storage devices 217. Computer system 501 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks, www.mathworks.com), SAS, SPSS, JavaScript, AJAX, Java, Python, Erlang, and Ruby on Rails. The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation).

An operating system for the system may be one of the Microsoft Windows® family of systems (e.g., Windows 95, 98, Me, Windows NT, Windows 2000, Windows XP, Windows XP x64 Edition, Windows Vista, Windows 7, Windows 8, Windows 10, Windows 11, Windows CE, Windows Mobile, Windows RT), Symbian OS, Tizen, Linux, HP-UX, UNIX, Sun OS, Solaris, Mac OS X, Apple iOS, Android, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac, and 802.11ad, just to name a few examples), near field communication (NFC), radio-frequency identification (RFID), mobile or cellular wireless (e.g., 2G, 3G, 4G, 3GPP LTE, WiMAX, LTE, LTE Advanced, Flash-OFDM, HIPERMAN, iBurst, EDGE Evolution, UMTS, UMTS-TDD, 1xRDD, and EV-DO). For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

In other implementations, the user accesses the system through either or both of native and nonnative applications. Native applications are locally installed on the particular computing system and are specific to the operating system or one or more hardware devices of that computing system, or a combination of these. These applications (which are sometimes also referred to as “apps”) can be updated (e.g., periodically) via a direct internet upgrade patching mechanism or through an applications store (e.g., Apple iTunes and App store, Google Play store, Windows Phone store, and Blackberry App World store).

The system can run in platform-independent, nonnative applications. For example, client can access the system through a web application from one or more servers using a network connection with the server or servers and load the web application in a web browser. For example, a web application can be downloaded from an application server over the Internet by a web browser. Nonnative applications can also be obtained from other sources, such as a disk.

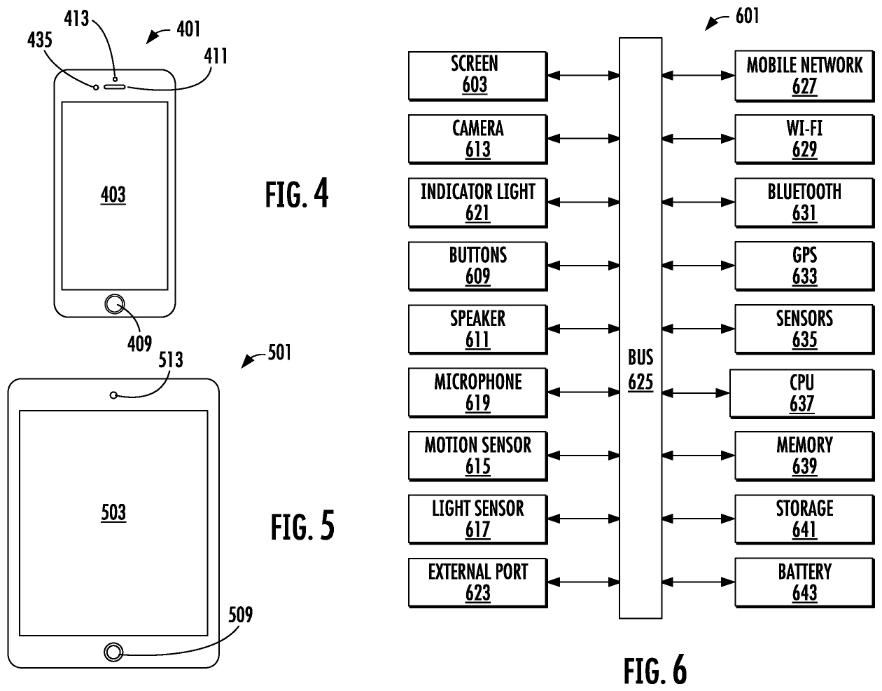

FIGS. 4-5 show examples of mobile devices, which can be mobile clients. Mobile devices are specific implementations of a computer, such as described above. FIG. 4 shows a smartphone device 401, and FIG. 5 shows a tablet device 501. Some examples of smartphones include the Apple iPhone, Samsung Galaxy, and Google Nexus family of devices. Some examples of tablet devices include the Apple iPad, Samsung Galaxy Tab, and Google Nexus family of devices.

Smartphone 401 has an enclosure that includes a screen 403, button 409, speaker 411, camera 413, and proximity sensor 435. The screen can be a touch screen that detects and accepts input from finger touch or a stylus. The technology of the touch screen can be a resistive, capacitive, infrared grid, optical imaging, or pressure-sensitive, dispersive signal, acoustic pulse recognition, or others. The touch screen is screen and a user input device interface that acts as a mouse and keyboard of a computer.

Button 409 is sometimes referred to as a home button and is used to exit a program and return the user to the home screen. The phone may also include other buttons (not shown) such as volume buttons and on-off button on a side. The proximity detector can detect a user's face is close to the phone, and can disable the phone screen and its touch sensor, so that there will be no false inputs from the user's face being next to screen when talking.

Tablet 501 is similar to a smartphone. Tablet 501 has an enclosure that includes a screen 503, button 509, and camera 513. Typically the screen (e.g., touch screen) of a tablet is larger than a smartphone, usually 7, 8, 9, 10, 12, 13, or more inches (measured diagonally).

FIG. 6 shows a system block diagram of mobile device 601 used to execute the software of the present invention. This block diagram is representative of the components of smartphone or tablet device. The mobile device system includes a screen 603 (e.g., touch screen), buttons 609, speaker 611, camera 613, motion sensor 615, light sensor 617, microphone 619, indicator light 621, and external port 623 (e.g., USB port or Apple Lightning port). These components can communicate with each other via a bus 625.

The system includes wireless components such as a mobile network connection 627 (e.g., mobile telephone or mobile data), Wi-Fi 629, Bluetooth 631, GPS 633 (e.g., detect GPS positioning), other sensors 635 such as a proximity sensor, CPU 637, RAM memory 639, storage 641 (e.g., nonvolatile memory), and battery 643 (e.g., lithium ion or lithium polymer cell). The battery supplies power to the electronic components and is rechargeable, which allows the system to be mobile.

This application also incorporates by reference U.S. patent application Ser. No. 17/316,489, filed May 10, 2021; 63/022,386, filed May 8, 2020; Ser. No. 16/810,821, filed Mar. 5, 2020, issued as U.S. Pat. No. 11,356,252 on Jun. 7, 2022; and 62/814,209, filed Mar. 5, 2019 and all other references cited in this application.

VPNs and VPN replacements are slow, expensive, and difficult to manage. Learn how Zero Trust Data protection offers a more future-proof, scalable approach to securing corporate data transfer and apps.

VPNs and VPN replacements protect the connection but not the data itself. VPNs and VPN replacements are increasingly vulnerable targets and the cause of costly breaches. Threat actors with VPN and VPN replacements credentials have free reign in your network to take anything. VPNs and VPN replacements are a clunky way to manage data access and can be bothersome to configure and maintain. VPN and VPN replacement services are often centralized, which is slow, and have access to your data that is not protected by policy-based access.

VPNs and other VPN replacements work on the same basic logic: the network, the applications, and the identity do not trust the data. XQ flips that paradigm on its head. XQ makes it so the data does not trust the network, application, or identity.

The XQ Zero Trust Data Protection Platform is a server side deployed instance. The instance functions as an encryption key, policy reporting, team and entropy management resource. Each instance is interoperable with other instances.

The XQ Gateway provides data level protection for data in motion.

The XQ Gateway is a software application that allows users to set up encrypted transmissions between one or more devices or applications. This is done with minimal to no reconfiguration necessary for the devices themselves. The gateway replaces traditional VPN and VPN replacement data transfer solutions by:
1. Ingest traffic from a defined source or sources
1a. Gateway supports OSI layers 2 through 7—VLAN through SFTP
2. Micro-segmenting data for encryption and tracking
3. Generate a unique, crypto agile key at the edge
4. Encrypt the received data (allowing the use of a new encryption key for every packet)
5. Add policies to the encrypted data object
5a. Which identities can read the data
5b. What geolocations are allowed to data decryption
5c. How long will the key be available before it is destroyed
5d. Custom data access policies
6. Send the key and policy to the XQ backend for storage, which returns a locator token
7. Transmit the encrypted data and locator token to a receiver (or receivers); and
8. Decrypt incoming data and route to a target device, or potentially store as-is for decryption later.

A single gateway is capable of handling multiple network connections, devices, and team configurations. Each gateway operates in tandem with at least one XQ backend. As such, all operations that make requests to the separate XQ backend are logged in the same way they would be if using the XQ API directly. These logs are available either on the device running the gateway, webhook, or on the corresponding external management portal.

The XQ Gateway is completely data-agnostic. Other than extracting known elements, it never scans your data and is not used for any type of content-based recognition. Data that needs to be categorized based on its content should be preconfigured to use different routes or mappings.

XQ Zero Trust Gateway Features: Zero Trust Data In Motion. Replace VPN. Cloud Manage VLAN Encryption and Routing. Transparently Encrypt/Decrypt in Transit. Data Policy Enforcement. Hybrid Cloud Transfer. Supports OSI VLAN to STFP. Cloud Manage VLAN Encryption and Routing. Azure, AWS, GCP, Redhat, Ubuntu deployable. Data Loss Prevention. Seamless access. Auditable data custody. Simple cloud-based management. CMMC, NIST, ITAR, HIPAA Rule Packs. Data Access Prevention.

VPN Alternative: Zero Trust Data Secure Connection. Zero Trust Data protection eases VPN maintenance burden. Easy to set up and use. Better data throughout. Improved compliance. Data sovereignty.

MACsec Alternative: Cloud manage VLAN encryption and routing. Remove the complexity of onsite MACsec management. Eliminate MACsec software license. Use non-MACsec switches. Reduce costs. Extend layer 2 to the cloud. Protect data across open networks

Tunnel, Connection, and Throughput: 5 Gbps Bandwidth. 1000 TCP Connections.

An XQ secure gateway includes multiple data processing routes. Each route can process incoming data in one of three ways: (1) Encryption: All incoming data will be encrypted and sent to the target device. (2) Decryption: All incoming data will be decrypted and sent to the target device. (3) Passthrough: All incoming data will be sent to the target device as it is received.

Once a gateway is configured and running, it immediately listens for data on all its routes.

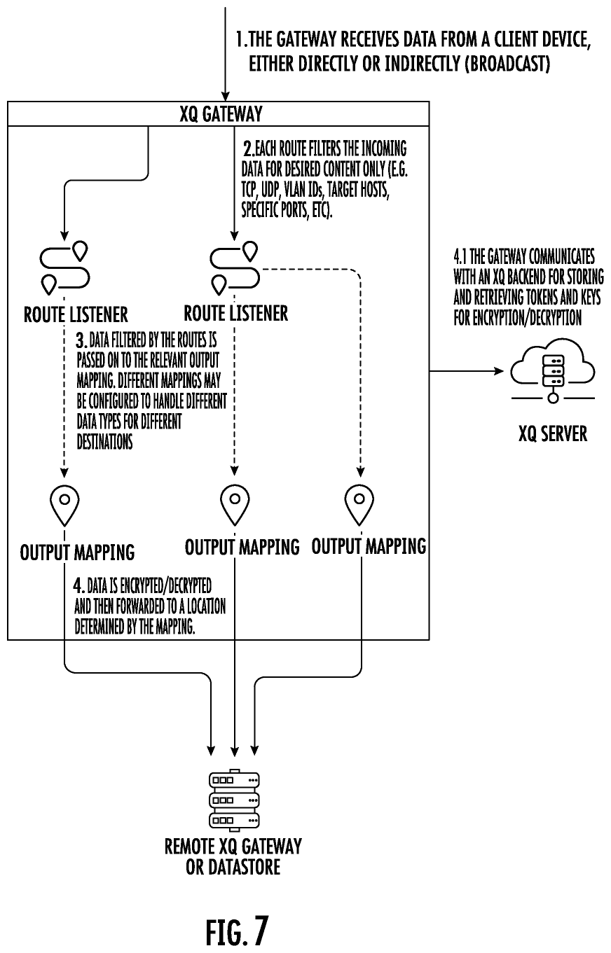

FIG. 7 shows a flow of data from a source device to a destination device. In reference number 1 (input to XQ gateway), the gateway receives data from a client device, either directly or indirectly (broadcast). In reference number 2 (route listener in gateway), each route filters the incoming data for desired content only (e.g., TCP, UDP, VLAN, IDs, target hosts, specific ports, and others). Filtering may be controlled by rules, policies, code, firmware, software, state machines, or other logic. In reference number 3 (route listener output mapping), data filtered by the routes is passed on to the relevant output mapping. Different mappings may be configured to handle different data types for different destinations. In reference number 4 (Data forwarded to location based on mapping), data is encrypted or decrypted, or both, and then forwarded to a location determined by the mapping (e.g., remote XQ gateway or datastore). In reference number 4.1 (XQ Server), the gateway communicates with an XQ backend for storing and retrieving token and keys for encryption or decryption, or both.

Basic Configuration. The gateway is configured using JSON and INI files either created by a web portal, or manually written. If enabled, the status of the gateway may also be periodically transmitted to the associated external backend, and allow for remote management features such as stopping, starting, and updating configurations. A sample routing JSON configuration is presented in the table below.

```
TABLE
{
  “log_level”:“info”,
  “devices”:[
    {
      “name”:“This Device”,
      “addresses”:[“10.0.0.1”,“11.0.0.1”],
      “local”:true
    }
  ],
  “configs”:[
    {
      “name”:“MyTeamConfig”,
      “team”: 2,
      “key”:“my_trusted_range_key”
    }
  ],
  “routes”: [
    {
      “title”:“Encrypt Incoming”,
      “type”:“enc”,
      “transport”:“standard”,
      “protocol”:“udp”,
      “port”:4000,
      “algorithm”:“OTP”,
      “recycle”: 300,
      “lifetime”: 1,
      “config”: “MyTeamConfig”,
      “recipients”:“devices@email.com”,
      “mapping”: [
        {
          “name”:“Encrypted Outgoing”,
          “interface”:“en1”,
            “transport”:“standard”,
          “protocol”:“udp”,
          “ip”:“192.168.1.2”,
          “port”:5000
        }
      ]
    }
  ]
}
```

Data Reception. All data received by a gateway will be initially filtered before secondary processing takes place (encryption, decryption or otherwise). Among others, the following properties are used for filtering: (i) Source Address and Port: The address and port of the gateway device. (ii) Network Interface (raw only): The network interface for receiving traffic. (iii) VLAN Identifier: Filter incoming packets based on their VLAN IDs. (iv) Type filters (raw only): These are specified in the mapping, and further filter the responses based on ether and protocol type before processing. (v) Devices: Also specified on mappings, this ties a mapping to specific devices and denies access to others.

When data arrives on a non-passthrough route, the following events occur:
1. The origin is checked for a match to any device specified in the routing configuration file.
2. The destination is checked against the mappings defined for the route. If no match is found (and there is no default catch-all mapping defined), the route is aborted.
3. If a valid mapping is found, the data will be sent to it for continued processing.

Output Processing. Once the data is passed to the mapping, the following actions occur:
1. Check whether a usable access token for the source device has previously been cached. If one exists, it will be used for the next steps. If not, a trusted authentication call is made to the backend by the gateway on behalf of the device (if the device was not specified in the configuration file, it is given a generic name). On success, an encrypted access token is returned that (once correctly decrypted by the gateway) will be used for this device in future requests.
2. For encryption routes, the gateway will:
(i) Check whether a usable key already exists that can be used for the upcoming encryption process.
(ii) If a valid one exists, it will be used for future steps. Otherwise, a new token will be requested. First, entropy is pulled from a quantum pool. That entropy then gets transformed into a unique hex key which gets transmitted to the XQ server in return for a locator token (the expiration and recipient policies set to what is configured for this route). The key/token pair is registered to this route so subsequent encryption attempts will use this key until the usage limit is reached, or time window has elapsed. This process is fully logged, and records of this transaction will be available on the management portal.
(iii) The payload is encrypted and ready for output processing. The encryption process itself takes place entirely on the client, thus is NOT logged remotely (preventing degraded performance from making multiple unnecessary remote calls). However, this data is fully available directly in the local logs if enabled.
3. For decryption routes, the gateway will:
(i) Extract the locator token from the payload.
(ii) Check if the key that is matched to that locator token is already cached. If a valid one exists, use that. Otherwise attempt to fetch the key from the XQ backend. If fetched, the key will be cached so that subsequent decryption attempts with the same token will not need to make a remote call. Like encryption, this process is fully logged and recorded.
(iii) The received payload is decrypted and ready for output processing.

For passthrough routes, the data is sent as-is for output processing.
4. After the data has been processed, it will be sent to the desired destination (which also gets detected during the output processing phase). Data will be transmitted in different ways depending on the mapping configuration:
5. Standard Transport: For simple data transfers over UDP and TCP, standard transport can be used to send data to the destination.
6. Raw Transport: This mode supports ether-types other than IPv4 and IPv6. It also allows for more control over information available in a packet header. This is useful for data transmissions that—for example—need to retain information from the data link and network layer of the original packet to accurately replay the transmission on another network. For OSI 2 (VLAN) the gateway can route by rerouted via software to a new VLAN channel over a raw socket,

### Sample Use Cases

A. Secure File Transfer Services. The XQ gateway can be used as a zero-trust file transfer pipeline between one or more hosts. A user may continue to use any file transfer application of their choice (FTP, RCP, SFTP, FTPS, and others). The inclusion of the XQ gateway ensures that all data transmitted gets encrypted with a continuously changing and time-limited key.

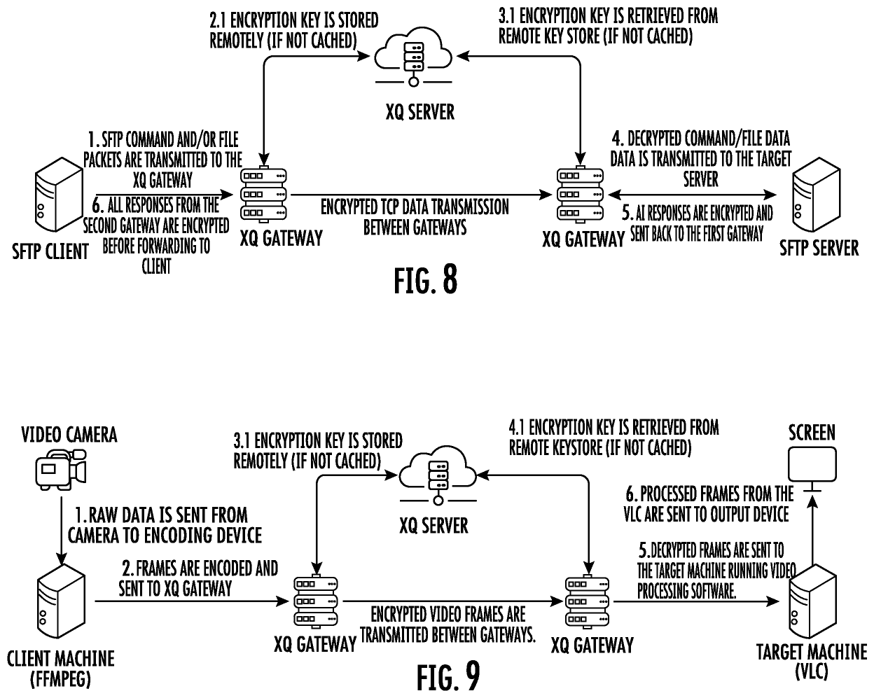

FIG. 8 shows a secure file services data flow example. In reference number 1, from an SFTP client, secure FTP (SFTP) command or file packets, or both, are transmitted to the XQ gateway (e.g., first gateway). In reference number 2.1, encryption key is store remotely, if not cached, such as at from the XQ gateway (e.g., first gateway) to the XQ server. Encrypted TCP data transmission occurs between XQ gateways, such as the first gateway to a second gateway.

In reference number 3.1, encryption key is retrieved from remote keystore (e.g., XQ server), if not cached. In reference number 4, decrypted command or file data is obtained via the XQ gateway (e.g., second gateway). Data is transmitted to the target server. In reference number 5, all responses are encrypted and sent back to the first gateway. In reference number 6, all responses from the second gateway are encrypted before forwarding to client.
1. The client starts up the file transfer application of their choice.
2. The client sets the file transfer application to connect to the gateway rather than directly to the file transfer server itself. e.g., via sftp:
sftp-P 5555 user@10.0.0.10

Where 10.0.0.10 and 5555 are the IP and port respectively of the gateway.
3. The XQ gateway encrypts the data using an encryption key that can optionally be reused either for a fixed length of time, or a fixed number of uses.
4. The encrypted request is forwarded to the target gateway that is connected to the file server.
5. The target gateway decrypts and forwards the request to the file server.
6. The request is processed, and—for TCP based protocols—the result is returned encrypted over the same socket.

B. Secure Media Streaming. The XQ gateway can be used for media streaming, allowing real-time audio and video streaming from one host to another.

FIG. 9 shows a secure media streaming data flow. In reference number 1, raw data is sent from a video camera to encoding device (e.g., client machine performing FFMPEG encoding). In reference number 2, frames are encoded and sent to XQ gateway. In reference number 3.1, encryption key is store remotely, if not cached, such as at from the XQ gateway (e.g., first gateway) to the XQ server. Encrypted video frames are transmitted between gateways, such as a first gateway to a second gateway.

In reference number 4.1, encryption key is retrieved from remote keystore (e.g., XQ server), if not cached (e.g., local cache or remote cache) by the second gateway. In reference number 5, decrypted frames are sent to the target machine running video processing software (e.g., VLC video or media player). In reference number 6, processed from the VLC player are send to an output device, such as a screen.

Video and audio packets are sent from the capture device to the target device in the following order:
1. The capture device (e.g., video camera, microphone) transmits raw data to a connected compute device.
2. The compute device encodes the frame data with the desired algorithm (e.g., H.264).
3. The compute device sends the encoded frame data to the connected XQ gateway.
4. The XQ gateway encrypts the data using an encryption key that can optionally be reused either for a fixed length of time, or a fixed number of uses.
5. The encrypted data is transmitted to a remote XQ gateway. Where the frame is decrypted and sent to a compute device.
6. The compute device decodes the A/V frame appropriately before rendering either the video or audio output.

C. Secure URL Hosting. The XQ gateway can be used as a secure web proxy either in combination with HTTPS or with regular HTTP alone:
1. The network TCP request is transmitted from the client browser (e.g., Chrome, Safari, or others) to the XQ gateway at the designated address and port.
2. The gateway encrypts the request and sends to the target gateway
3. The target gateway decrypts and forwards the HTTPS request to the web server.
4. The request is processed, and the result is returned on the same TCP socket.
5. The response is encrypted using the same key that was used for encryption and sent back to the original gateway.
6. The original gateway decrypts the response and forwards the result to the client browser.

D. Secure Intranet Bridging. The XQ gateway can be used to bridge communications of two or more LANs across a wider network. Considering two networks: SUBNET A (containing DEVICE-A and DEVICE-B) and SUBNET-B (containing DEVICE-C and DEVICE-D).

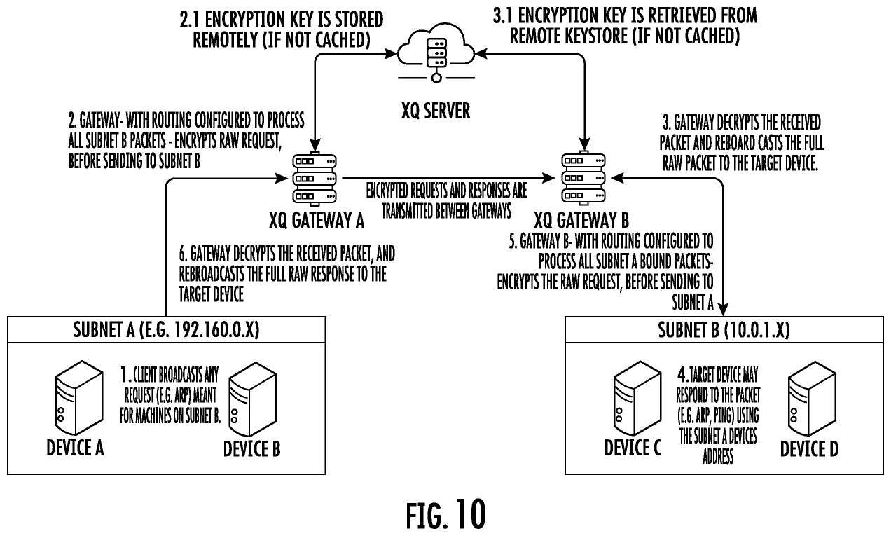

FIG. 10 shows a secure network bridging data flow example. In reference number 1, client on a subnet A broadcasts any request (e.g., ARP) meant for machines on subnet B. On subnet A (e.g., 192.16.0.x), there are devices A and B. In reference number 2, a gateway (e.g., XQ gateway A) with routing configured to process subnet B packets encrypts raw request before sending to subnet B. In reference number 2.1, encryption key is store remotely, if not cached, at an XQ server. Encrypted request and responses are transmitted between gateways, XQ gateway A and XQ gateway B.

In reference number 3.1, encryption key is retrieved from a remote keystore, if not cached, at the XQ server. In reference number 3, a gateway decrypts the received packet and rebroadcasts the full raw packet to the target device. In reference number 4, target device may respond to the packet (e.g, ARP, PINT) using the subnet A devices address. On subnet B (e.g., 10.0.1.x), there are devices C and D. In reference number 5, gateway B with routing configured to process subnet A bound packets encrypts the raw request before sending to subnet A.
1. Raw requests from devices on SUBNET-A to devices on SUBNET-B are sent out directly. These could be UDP, TCP, ARP, ICMP or any other type of raw request.
2. Gateway A intercepts any requests bound for SUBNET-B. It then encrypts that request and sends to Gateway B.
3. Gateway B receives the incoming packet, decrypts, and replays the resulting raw packet on this network.
4. The target device (DEVICE-A or DEVICE-D) will receive the frame. As this frame will usually still reference the original source device in its layer-2 header the gateway itself remains transparent.
5. Requests in the other direction will be processed in the same manner.

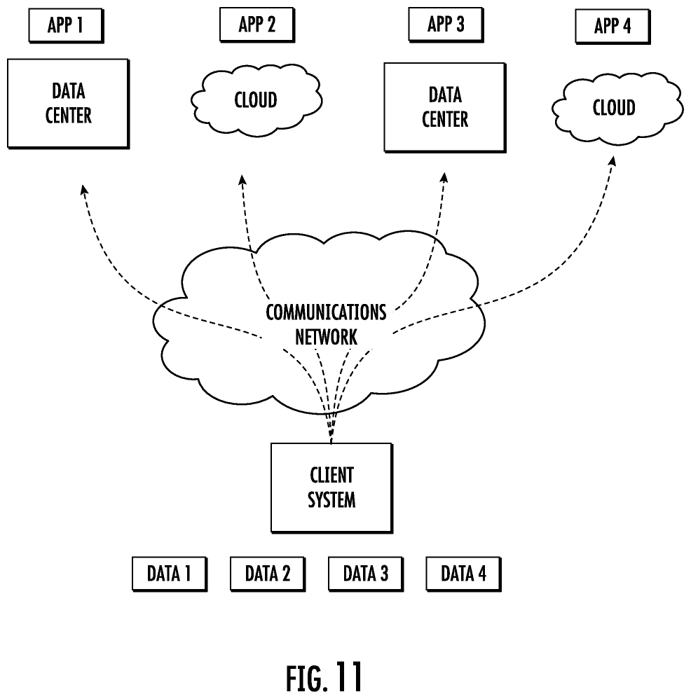

FIG. 11 a client system making secure network connections with two or more different endpoints via a communications network or gateway described in this application. For example, the client system can have four different types of data, such as Data 1, Data 2, Data 3, and Data 4. This data may be streaming or other data from the client, such as sensors or other Internet of Things (IoT) data at what is referred as edge data.

This data is sent via a secure network connection (e.g., VPN-type connection) through the gateway (e.g., communications network) to four different endpoints, represented by App 1 (Data Center), App2 (Cloud), App 3 (Data Center), and App 4 (Cloud). The gateway will intelligently transmit the data to the appropriate endpoint by using rules that the gateway has. So, the client system will have a secure VPN-type connection from a single starting point to four different endpoints. The client system has a single network adapter.

In an implementation, each secure network connection is secured using a different encryption key. This improves the security of the system. So if one of the secure network connections is broken, then the other secure network connections will remain unbroken. In a typical VPN or other secure network, once the security of a single connection is broken, the entire network is broken; this is because the communication is secured using the same encryption key. Also, depending on the desired security, a network can use different levels of encryption for different secure channels. For example, some encryption keys can be more secured (e.g., longer key) than others. And where less security is acceptable, it is possible to use the same encryption key for all channels, or any two or more channel. The gateway allows much greater flexibility and capabilities than other secure communication approaches.

With traditional VPNs, there is a single starting point and single endpoint. It is difficult to create simultaneous VPNs between a single client and multiple endpoints, where the single client has only a single network adapter. With a communications network or gateway as described in this application, a secure application layer connection can be made simultaneously between a single client and multiple endpoints, where the client has only a single network adapter.

An issue problem with VPNs is that they are site to site; thus all application traffic goes from the client system to the application server. However there are many situations where the data from a client should travel to different application servers. For example in a smart manufacturing site with robots, the data from a single robot might call for travel to an artificial intelligence (AI) imaging platform, an energy management system, and a separate maintenance system, all operated by different vendors at different locations with different security policies.

Similarly a smart energy system will transmit information from a building to multiple partners such as an energy utility or building management system. Unfortunately VPNs are typically owned and operated by a single enterprise and thus are not designed for multi-tenant applications.

A gateway of this application, such as XQ's Zero Trust Data, utilizes an agent on the client system that is able to identify different data packets by examining the payload or looking at the port address and then route them to different application servers. Every application packet is encrypted with a different key to ensure that access policies are enforced following the Zero Trust security model.

The Zero Trust Data approach to protecting application data going from one source computer to multiple destinations is different from a SSL VPN with utilize a common certificate for all application traffic creating vulnerabilities. With XQ every application data stream has a different encryption key and access policy. Another important difference between existing VPN gateways and XQ is that typically multiple edge nodes connect to a centralized VPN gateway. With XQ the edge nodes can connect to multiple sites directly.

XQ's zero trust data is different from VPNs as VPNs are computer to computer (or virtual computer) where XQ is applications on one device to applications on multiple computers. XQ's approach is easier to deploy in complex environments where an edge node must communication with applications in different locations simultaneously.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
establishing a first secure connection between a first client and a first gateway;
receiving first data over the first secure connection from the first client at the first gateway;
at the first gateway, filtering the first data and mapping the first data in a first subdata and second subdata;
transmitting the first subdata to a first location via second secure connection; and
transmitting the second subdata to a second location via a third secure connection, wherein the second location is different from the first location.

2. The method of claim 1 wherein the first secure connection, second secure connection, and third secure connection are encrypted connections.

3. The method of claim 1 wherein the filtering at the gateway is performed based on rules or policies stored at the gateway.

4. The method of claim 1 comprising:
transmitting the first subdata to a second gateway via a fourth secure connection.

5. The method of claim 4 comprising:
transmitting the second subdata to a third gateway via a fifth secure connection.

6. The method of claim 1 comprising:
using a first encryption key to encrypt first data transmitted over the first secure connection;
transmitting the first encryption key from the first gateway to the a server;
storing the first encryption key at the server;
at a second gateway, receiving the first encryption key from the server; and
using the first encryption key to encrypt first subdata transmitted over the second secure connection.

7. The method of claim 1 wherein the first data comprises an encoded video stream.

8. The method of claim 1 wherein the first data comprises secure file transfer protocol (SFTP) data.

9. The method of claim 1 wherein the first client is on a first subnet and the first location is on a second subnet, different from the first subnet.

10. The method of claim 1 wherein the first secure connection is encrypted using a first encryption key, the second secure connection is encrypted using a second encryption key, and the third secure connection is encrypted using a third encryption key, where the first, second, and third encryption keys are different from each other.

11. A method comprising:
using only one network adapter interface, establishing a first secure connection between a first client and a first application endpoint and a second application endpoint over which to transmit data,
wherein the establishing a first secure connection comprises
establishing a second secure connection between the first client and a first gateway;
receiving first data over the first secure connection from the first client at the first gateway;
at the first gateway, filtering the first data to obtain a first subdata and second subdata;
transmitting the first subdata to a first application endpoint via fourth secure connection; and
transmitting the second subdata to a second application endpoint via a fourth secure connection, wherein the second application endpoint is different from the first application endpoint.

12. The method of claim 11 wherein the filtering at the gateway is performed based on rules or policies stored at a gateway.

13. The method of claim 11 wherein the first data of the first client comprises data from a first application or sensor of the first client and a second application of the first client.

14. The method of claim 11 comprising:
storing an encryption key at a server, wherein the encryption key is used to encrypt first data.

15. The method of claim 14 comprising:
retrieving the encryption key from the server, wherein the encryption key is used to decrypt first subdata.
